(19) United States
(12) Patent Application Publication
(10) Pub. No.: US 2020/0009583 A1
(43) Pub. Date: Jan. 9, 2020

(54) CENTRIFUGAL SEPARATOR AND METHOD OF ASSEMBLING

(71) Applicants: Mahendra Ladharam JOSHI, Niskayuna, NY (US); Subrata PAL, Niskayuna, NY (US); Xuele QI, Niskayuna, NY (US); Fengguo TIAN, Niskayuna, NY (US); Ying ZHOU, Pudong, Shanghai (CN); GENERAL ELECTRIC COMPANY, Schenectady, NY (US)

(72) Inventors: Mahendra Ladharam JOSHI, Katy, TX (US); Subrata PAL, Bangalore, Karnataka (IN); Xuele QI, Edmond, OK (US); Fengguo TIAN, Pudong, Shanghai (CN); Ying ZHOU, Pudong, Shanghai (CN)

(73) Assignee: General Electric Company, Schenectady, NY (US)

(21) Appl. No.: 16/488,382

(22) PCT Filed: Feb. 23, 2017
(86) PCT No.: PCT/CN2017/074614

§ 371 Date: Aug. 23, 2019

(51) Int. Cl. B04B 5/12; B01D 17/02; B01D 19/00; E21B 43/38; B04B 1/04

(52) U.S. Cl. CPC B04B 5/12; B01D 17/0217; B01D 2221/04; E21B 43/38; B04B 1/04; B01D 19/0052

(57) ABSTRACT

A centrifugal separator includes a stator assembly (114) that includes at least one housing (116), and a rotor assembly (112) positioned within the at least one housing. The rotor assembly includes a rotor shaft (132), an array of longitudinal fins (189) extending radially outward from the rotor shaft, and a plurality of separator vanes (134) coupled to the array of longitudinal fins. Each separator vane includes a plurality of longitudinal slots (194) defined therein and configured to align with the array of longitudinal fins such that the plurality of separator vanes are rotationally interlocked with the array of longitudinal fins.

### BACKGROUND

The present disclosure relates generally to centrifugal separation and, more specifically, to a centrifugal separator having a compact design and improved separation control.

Hydraulic fracturing, commonly known as fracing, is a technique used to release petroleum, natural gas, and other hydrocarbon-based substances for extraction from underground reservoir rock formations, especially for unconventional reservoirs. The technique includes drilling a wellbore into the rock formations, and pumping a treatment fluid into the wellbore, which causes fractures to form in the rock formations and allows for the release of trapped substances produced from these subterranean natural reservoirs.

At least some known treatment fluids are formed at least partially from water, and the water is sometimes released from the fractures and backflows into the wellbore such that a mixture of water and released hydrocarbon-based substances is formed. The water and hydrocarbon-based substances are then separated from each other such that the hydrocarbon-based substances can be recovered for subsequent refinement. In addition, the water and hydrocarbon-based substances can be separated within the wellbore or at ground level. However, the wellbore is typically sized such that the use of many known separating devices within the wellbore is limited. Moreover, at least some known separating devices have design limitations that limit their effectiveness in separating a mixture containing water and hydrocarbon-based substances.

### BRIEF DESCRIPTION

In one aspect, a centrifugal separator is provided. The centrifugal separator includes a stator assembly including at least one housing, and a rotor assembly positioned within the at least one housing. The rotor assembly includes a rotor shaft, an array of longitudinal fins extending radially outward from the rotor shaft, and a plurality of separator vanes coupled to the array of longitudinal fins. Each separator vane includes a plurality of longitudinal slots defined therein and configured to align with the array of longitudinal fins such that the plurality of separator vanes are rotationally interlocked with the array of longitudinal fins.

In another aspect, a pump assembly for use in extracting fluid from a wellbore is provided. The pump assembly includes a submersible pump, and a centrifugal separator in flow communication with the submersible pump. The centrifugal separator includes a stator assembly including at least one housing configured to channel a mixed stream of at least a first fluid and a second fluid therethrough, and a rotor assembly positioned within the at least one housing. The rotor assembly includes a rotor shaft, and a plurality of separator vanes coupled to the rotor shaft. A plurality of angled flow passages are defined between adjacent separator vanes, a radially outer flow passage is defined between the plurality of separator vanes and the at least one housing, and a radially inner flow passage is defined between the plurality of separator vanes and the rotor shaft. The plurality of angled flow passages are configured to provide flow communication between the radially outer flow passage and the radially inner flow passage such that, when the rotor assembly rotates, the mixed stream is separated based on a density of the first fluid and the second fluid.

In yet another aspect, a method of assembling a centrifugal separator is provided. The method includes sliding a plurality of separator vanes onto a rotor assembly that includes a rotor shaft and an array of longitudinal fins extending radially outward from the rotor shaft. The plurality of separator vanes include a plurality of longitudinal slots defined therein and configured to align with the array of longitudinal fins such that the plurality of separator vanes are rotationally interlocked with the array of longitudinal fins. The method further includes positioning the rotor assembly within at least one housing of a stator assembly.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an exemplary pump assembly;

FIG. 2 is a partially transparent perspective view of an exemplary centrifugal separator that may be used with the pump assembly shown in FIG. 1;

FIG. 3 is a perspective view of an exemplary rotor assembly that may be used with the centrifugal separator shown in FIG. 2;

FIG. 4 is a cross-sectional view of the centrifugal separator shown in FIG. 2;

FIG. 5 is an enlarged cross-sectional view of a portion of the centrifugal separator shown in FIG. 4, taken along Area 5; and

FIG. 6 is an exemplary series of process steps for use in assembling the centrifugal separator shown in FIG. 2.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

Embodiments of the present disclosure relate to a centrifugal separator having a compact design and improved separation control. More specifically, the centrifugal separator includes a rotor assembly including a plurality of separator vanes that define a radially outer flow passage, a radially inner flow passage, and a plurality of angled flow passages that provide flow communication between the two flow passages. In operation, a mixed stream of at least a high density fluid and a low density fluid is channeled within the centrifugal separator. As the rotor assembly rotates, the high density fluid is forced radially outward towards the radially outer flow passage. Moreover, the angled flow passages are oriented to facilitate channeling fluid vertically though the centrifugal separator, and such that the low density fluid is channeled through the angled flow passages and towards the radially inner flow passage when displaced by the high density fluid in the radially outer flow passage. Separation of the high density fluid and the low density fluid increases as the mixed stream is channeled within the centrifugal separator and past successive separator vanes. The separator vanes are arranged in series within the centrifugal separator, and the number of vanes included therein is selected based on a desired separation of the mixed stream. As such, the centrifugal separator described herein has a flow path design that facilitates enhancing the stability of the separation process in a space-saving and efficient manner.

As used herein, the terms “axial” and “axially” refer to directions and orientations that extend substantially parallel to a longitudinal axis of the centrifugal separator. Moreover, the terms “radial” and “radially” refer to directions and orientations that extend substantially perpendicular to the longitudinal axis of the centrifugal separator. In addition, as used herein, the terms “circumferential” and “circumferentially” refer to directions and orientations that extend arcuately about the longitudinal axis of the centrifugal separator.

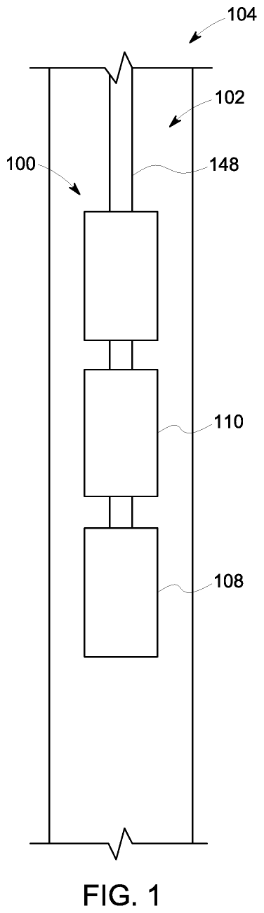

FIG. 1 is a schematic illustration of an exemplary pump assembly 100 positioned within a wellbore 102 formed in a subterranean rock formation 104. In the exemplary embodiment, pump assembly 100 includes an electrical submersible pump (ESP) 106 and a centrifugal separator 108 in flow communication with ESP 106. ESP 106 pumps fluid (not shown) within wellbore 102 towards a ground level (not shown) above subterranean rock formation 104. In some embodiments, the fluid is formed from a mixture of at least a first fluid having a first density and a second fluid having a second density less than the first density. An exemplary first fluid includes, but is not limited to water having a specific gravity defined within a range between about 1.0 and about 1.25. An exemplary second fluid includes, but is not limited to, hydrocarbon-based substances such as oil having an American Petroleum Institute (API) gravity defined within a range between about 20 and about 50. Centrifugal separator 108 receives a mixed stream of the first fluid and the second fluid, and is operable to separate the mixed stream such that a purified stream of the greater density first fluid is formed and discharged therefrom, as will be explained in more detail below. While described in the context of water and oil separation, it should be understood that centrifugal separator 108 is capable of separating any mixture of fluids having different densities.

In the exemplary embodiment, ESP 106 is positioned above (i.e., shallower within wellbore 102) than centrifugal separator 108. In such an embodiment, pump assembly 100 further includes a flow straightening device 110 positioned between ESP 106 and centrifugal separator 108. More specifically, fluid discharged from centrifugal separator 108 has a rotational component that can facilitate reducing the efficacy of ESP 106. As such, fluid discharged from centrifugal separator 108 is channeled past flow straightening device 110 before entering ESP 106 to reduce the rotational component of the fluid. In an alternative embodiment, ESP 106 is positioned below centrifugal separator 108. In a further alternative embodiment, centrifugal separator 108 is located at the ground level above subterranean rock formation 104.

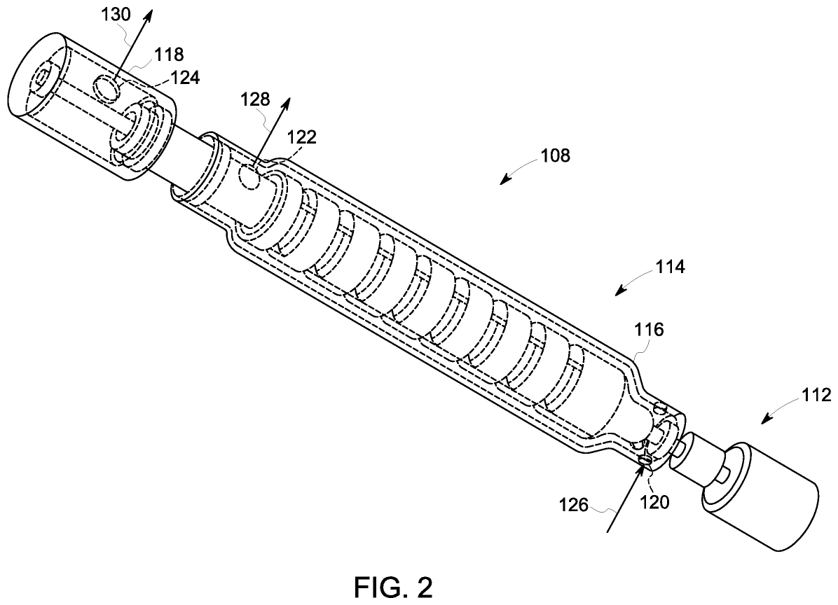

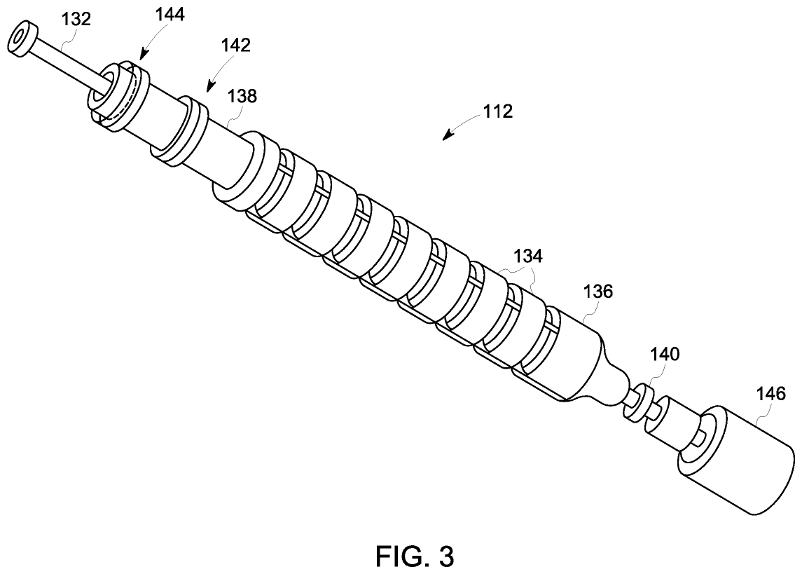

FIG. 2 is a partially transparent perspective view of an exemplary centrifugal separator 108 that may be used with pump assembly 100 (shown in FIG. 1), and FIG. 3 is a perspective view of an exemplary rotor assembly 112 that may be used with centrifugal separator 108. In the exemplary embodiment, centrifugal separator 108 includes stator assembly 114 including at least one housing, and rotor assembly 112 positioned within the at least one housing. More specifically, stator assembly 114 includes a first housing 116 and a second housing 118. First housing 116 includes an inlet 120 and a first outlet 122, and second housing 118 includes a second outlet 124. In operation, as will be explained in more detail below, inlet 120 receives a mixed stream 126 of at least a first fluid and a second fluid, and mixed stream 126 is separated within first housing such that a purified stream 128 of first fluid is discharged from first outlet 122, and a mixed stream 130 of the first fluid and second fluid is discharged from second outlet 124.

Referring to FIG. 3, rotor assembly 112 includes a rotor shaft 132 and a plurality of separator vanes 134 coupled to rotor shaft 132. Rotor assembly 112 further includes a diffuser 136 and a flow conduit 138 coupled to rotor shaft 132. Diffuser 136 and flow conduit 138 facilitate defining flow passages within centrifugal separator 108, as will be explained in more detail below. Centrifugal separator 108 further includes a bearing 140, a first bearing and seal assembly 142, and a second bearing and seal assembly 144. Bearing 140, first bearing and seal assembly 142, and second bearing and seal assembly 144 facilitate enabling rotation of rotor assembly 112 relative to stator assembly 114. In addition, first bearing and seal assembly 142 and second bearing and seal assembly 144 facilitate sealing first housing 116 and second housing 118 (both shown in FIG. 2) from each other. As such, purified stream 128 and mixed stream 130 are discharged from centrifugal separator 108 as distinct flows.

In the exemplary embodiment, centrifugal separator 108 further includes a motor 146 coupled to rotor shaft 132. Motor 146 is operable to actuate centrifugal separator 108, and to cause rotation of rotor assembly 112 relative to stator assembly 114. For example, in some embodiments, rotor assembly 112 rotates at a speed of less than about 4000 rotations per minute to facilitate separating the first fluid and the second fluid. In addition, motor 146 enables centrifugal separator 108 to be independently operable from other components in pump assembly 100 (shown in FIG. 1). In an alternative embodiment, referring to FIG. 1, pump assembly 100 includes a drive shaft 148 coupled to rotor shaft 132 and motor 146 is omitted from centrifugal separator 108. As such, centrifugal separator 108 is actuated by rotation of drive shaft 148.

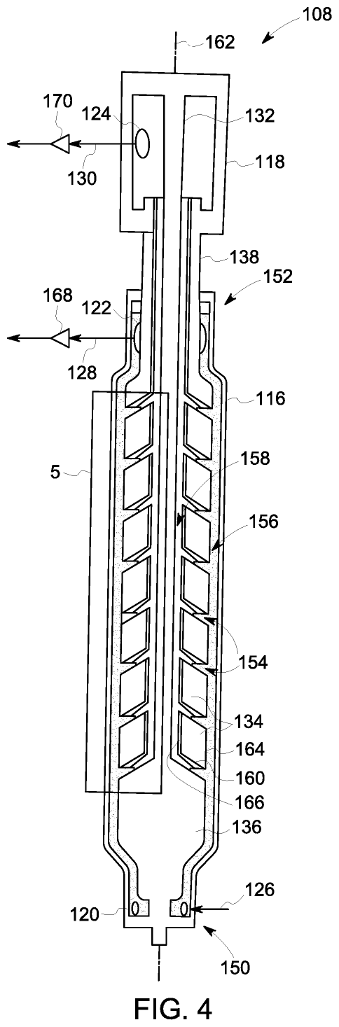

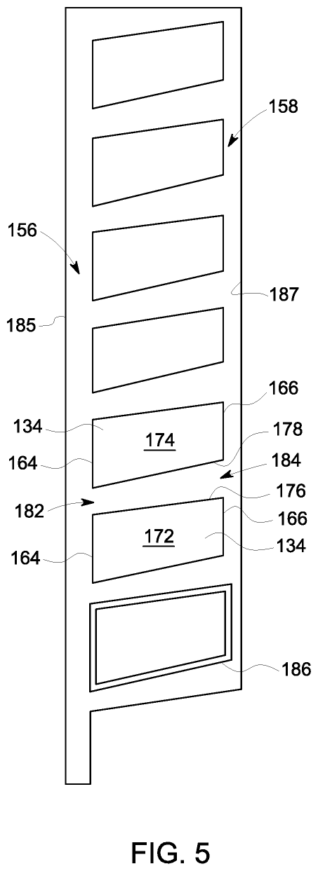

FIG. 4 is a cross-sectional view of centrifugal separator 108, and FIG. 5 is an enlarged cross-sectional view of a portion of centrifugal separator 108, taken along Area 5 (shown in FIG. 4). In the exemplary embodiment, first housing 116 includes an inlet end 150 and an outlet end 152, and the plurality of separator vanes 134 are arranged sequentially within first housing 116 from inlet end 150 towards outlet end 152. Moreover, a plurality of angled flow passages 154 are defined between adjacent separator vanes 134, a radially outer flow passage 156 is defined between the plurality of separator vanes 134 and first housing 116, and a radially inner flow passage 158 is defined between the plurality of separator vanes 134 and rotor shaft 132. More specifically, each separator vane 134 includes at least one angled flow surface 160 oriented obliquely relative to a longitudinal axis 162 of rotor assembly 112 such that angled flow passages 154 are defined between adjacent separator vanes 134. As such, the plurality of angled flow passages 154 provide flow communication between radially outer flow passage 156 and radially inner flow passage 158 such that, when rotor assembly rotates, mixed stream 126 is separated based on a density of the first fluid and the second fluid.

In addition, separator vanes 134 each include a radially outer surface 164 and a radially inner surface 166 such that radially outer flow passage 156 is defined between first housing 116 and radially outer surface 164, and such that radially inner flow passage 158 is defined between rotor shaft 132 and radially inner surface 166. Moreover, as described above, first housing 116 includes inlet 120 and first outlet 122, and second housing 118 includes second outlet 124. First outlet 122 is in flow communication with radially outer flow passage 156, and second outlet 124 is in flow communication with radially inner flow passage 158.

As such, in operation, mixed stream 126 enters first housing 116 through inlet 120 and is channeled from inlet end 150 towards outlet end 152 of first housing 116. More specifically, mixed stream 126 is channeled from inlet end 150 towards outlet end 152 as rotor assembly 112 rotates. In addition, mixed stream 126 is separated based on a density of the first fluid and the second fluid. For example, the first fluid, which has a greater density than the second fluid, is forced radially outward towards radially outer flow passage 156 as rotor assembly 112 rotates and a centrifugal force is formed. As such, the percentage of the first fluid in the fluid channeled within radially outer flow passage 156 progressively increases from inlet end 150 towards outlet end 152, thereby forming purified stream 128 of first fluid for discharge from first outlet 122.

Moreover, the second fluid within mixed stream 126 is displaced from radially outer flow passage 156 as rotor assembly 112 rotates. More specifically, the second fluid is forced from radially outer flow passage 156, through angled flow passages 154, and into radially inner flow passage 158 as rotor assembly 112 rotates. In some embodiments, residual first fluid is also channeled through angled flow passages 154 and towards radially inner flow passage 158 as radially outer flow passage 156 reaches its capacity for containing separated first fluid therein. As such, mixed stream 130 is channeled from radially inner flow passage 158, through flow conduit 138 and towards second housing 118 for discharge from second outlet 124.

In one embodiment, pump assembly 100 (shown in FIG. 1) further includes a first outflow valve 168 in flow communication with first outlet 122, and a second outflow valve 170 in flow communication with second outlet 124. First outflow valve 168 and second outflow valve 170 restrict flow discharged from respective outlets such that a back pressure is formed within first housing 116 and second housing 118. As such, discharge of the lighter density second fluid, which flows at a greater rate than the first fluid, from centrifugal separator 108 is restricted to facilitate inducing separation of the first fluid and the second fluid within centrifugal separator 108. In an alternative embodiment, a single outflow valve in flow communication with second outlet 124 is included in pump assembly 100.

As described above, each separator vane 134 includes at least one angled flow surface 160 oriented obliquely relative to a longitudinal axis 162 of rotor assembly 112. Referring to FIG. 5, the plurality of separator vanes 134 includes at least a first separator vane 172 and a second separator vane 174. First separator vane 172 includes a first angled flow surface 176, and second separator vane 174 includes a second angled flow surface 178. In the exemplary embodiment, first angled flow surface 176 and second angled flow surface 178 are positioned to define an angled flow passage 180 therebetween. Angled flow passage 180 includes an intake opening 182 and a discharge opening 184. The flow area of intake opening 182 is defined by its radius, and the flow area of discharge opening 184 is defined by its radius. In addition, first angled flow surface 176 is oriented obliquely relative to second angled flow surface 178 such that intake opening 182 and discharge opening 184 have the same flow area. As such, the flow area of angled flow passage 180 remains constant such that the lighter density fluid flows from radially outer flow passage 156 towards radially inner flow passage 158 with.

Moreover, as described above, separator vanes 134 each include radially outer surface 164 and radially inner surface 166 such that radially outer flow passage 156 is defined between first housing 116 and radially outer surface 164, and such that radially inner flow passage 158 is defined between rotor shaft 132 and radially inner surface 166. In the exemplary embodiment, first housing 116 includes a side wall 185 that is oriented obliquely relative to longitudinal axis 162. More specifically, side wall 185 is angled such that a flow area of radially outer flow passage 156 decreases in size from inlet end 150 towards outlet end 152. In addition, rotor shaft 132 includes a surface 187 that is oriented obliquely relative to longitudinal axis 162. More specifically, surface 187 is angled such that a flow area of radially inner flow passage 158 increases in size from inlet end 150 towards outlet end 152. Increasing the flow area of radially inner flow passage 158 facilitates increasing its volumetric capacity and ability to contain additional second fluid. As such, the second fluid is restricted from backflowing towards radially outer flow passage 156. In an alternative embodiment, side wall 185 and surface 187 define a substantially cylindrical flow area therebetween, and a diameter of separator vanes 134 are varied to modify the flow area of radially outer flow passage 156 and radially inner flow passage 158.

As described above, the second fluid is less dense than the first fluid, which results in the second fluid being discharged from second outlet 124 at a greater rate than the first fluid discharged from first outlet 122, and results in a differential pressure being formed across first outlet 122 and second outlet 124. In some embodiments, radially outer surfaces 164 of the plurality of separator vanes 134 are oriented such that a flow area of radially outer flow passage 156 decreases in size from inlet end 150 towards outlet end 152. Decreasing the flow area of radially outer flow passage 156, and/or increasing the flow area of radially inner flow passage 158, facilitates equalizing the pressure differential formed across first outlet 122 and second outlet 124 by modifying the flow rate of the fluid channeled therethrough.

In one embodiment, a layer 186 of hydrophobic coating material is applied on at least one of stator assembly 114 or rotor assembly 112. For example, layer 186 is applied to any internal flow surface of stator assembly 114 or rotor assembly 112 that enables centrifugal separator 108 to function as described herein. The hydrophobic coating material facilitates reducing clogging and residue buildup from forming within centrifugal separator 108.

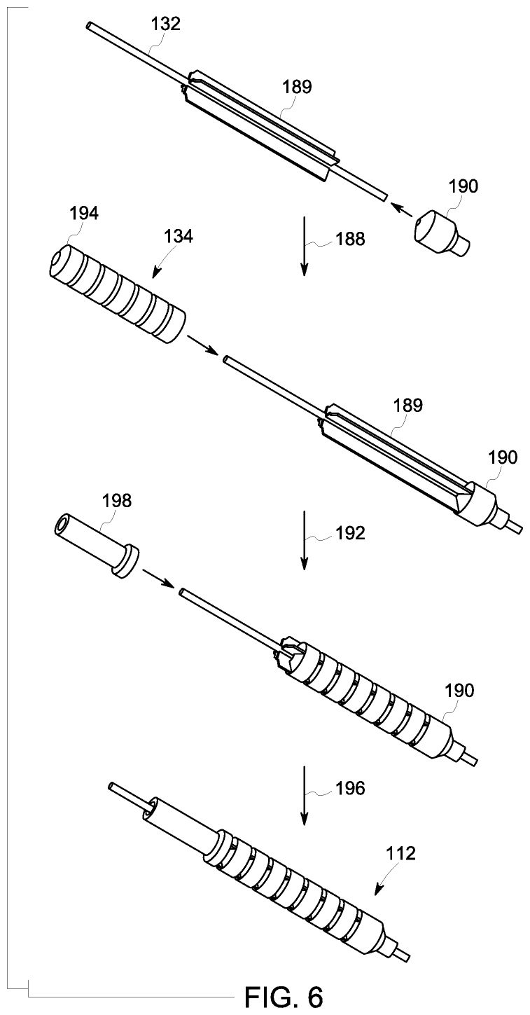

FIG. 6 is an exemplary series of process steps for use in assembling centrifugal separator 108 (shown in FIG. 2). In the exemplary embodiment, rotor assembly 112 includes rotor shaft 132 and an array of longitudinal fins 189 extending radially outward from rotor shaft 132. The array of longitudinal fins 189 are either formed separately from rotor shaft 132, or formed with rotor shaft 132 as a unitary monolithic structure. In a first process step 188, a diffuser element 190 is slid onto rotor shaft 132.

In a second process step 192, a plurality of separator vanes 134 are slid onto rotor assembly. In the exemplary embodiment, separator vanes 134 include a plurality of longitudinal slots 194 arranged circumferentially therein. The plurality of longitudinal slots 194 correspond with the array of longitudinal fins 189 such that the plurality of longitudinal slots 194 align with the array of longitudinal fins 189, and such that the plurality of separator vanes 134 are rotationally interlocked with the array of longitudinal fins 189. In addition, second process step 192 enables rotor assembly 112 to be assembled with any number of separator vanes 134 that enables centrifugal separator 108 to function as described herein.

In a third process step 196, a flow conduit element 198 is slid onto rotor shaft 132 such that rotor assembly 112 is formed. Rotor assembly 112 is then positioned within at least one housing of stator assembly 114.

The centrifugal separator described herein facilitates separating a mixed stream of fluid in a space-saving and efficient manner. The centrifugal separator includes a plurality of separator vanes than define inclined and angled flow passages within the centrifugal separator. The inclined and angled flow passages enable multi-stage separation to be performed within the centrifugal separator. Separation control is achieved by controlling the operating speed of the separator, and also by adjusting the number of separator vanes included in the separator. In addition, simple single phase flow meters (i.e., an orifice plate, a venturi meter, a vortex meter, and a differential pressure sensor) may be installed at the oil and water outlets to offer a digital solution for well, pad, or field optimization along with two-phase separation of oil and water.

An exemplary technical effect of the device and methods described herein includes at least one of: (a) separating a mixture including at least two fluids having different densities; (b) providing a centrifugal separator capable of use in enclosed, confined, or otherwise space-limited areas; and (c) providing an assembly that is easily adjustable to effectively separate a mixture having any two fluids having different densities.

Exemplary embodiments of a centrifugal separator are provided herein. The devices and methods are not limited to the specific embodiments described herein, but rather, components of systems and/or steps of the methods may be utilized independently and separately from other components and/or steps described herein. For example, the configuration of components described herein may also be used in combination with other processes, and is not limited to practice with only separating oil and water mixtures, as described herein. Rather, the exemplary embodiment can be implemented and utilized in connection with many applications where separating a mixture into its component parts is desired.

Although specific features of various embodiments of the present disclosure may be shown in some drawings and not in others, this is for convenience only. In accordance with the principles of embodiments of the present disclosure, any feature of a drawing may be referenced and/or claimed in combination with any feature of any other drawing.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

### Centrifugal Separator and Method of Assembling

PARTS LIST

| | |
|---|---|
| Pump assembly | 100 |
| Wellbore | 102 |
| Subterranean rock formation | 104 |
| ESP | 106 |
| Centrifugal separator | 108 |
| Flow straightening device | 110 |
| Rotor assembly | 112 |
| Stator assembly | 114 |
| First housing | 116 |
| Second housing | 118 |
| Inlet | 120 |
| First outlet | 122 |
| Second outlet | 124 |
| Mixed stream | 126 |
| Purified stream | 128 |
| Mixed stream | 130 |
| Rotor shaft | 132 |
| Separator vanes | 134 |
| Diffuser | 136 |
| Flow conduit | 138 |
| Bearing | 140 |
| Seal assembly | 142 |
| Seal assembly | 144 |
| Motor | 146 |
| Drive shaft | 148 |
| Inlet end | 150 |
| Outlet end | 152 |
| Angled flow passages | 154 |
| Radially outer flow passage | 156 |
| Radially inner flow passage | 158 |
| Angled flow surface | 160 |
| Longitudinal axis | 162 |
| Radially outer surface | 164 |
| Radially inner surface | 166 |
| First outflow valve | 168 |
| Second outflow valve | 170 |
| First separator vane | 172 |
| Second separator vane | 174 |
| First angled flow surface | 176 |
| Second angled flow surface | 178 |
| Angled flow passage | 180 |
| Intake opening | 182 |
| Discharge opening | 184 |
| Side wall | 185 |
| Layer | 186 |
| Surface | 187 |
| First process step | 188 |
| Longitudinal fins | 189 |
| Diffuser element | 190 |
| Second process step | 192 |
| Plurality of longitudinal slots | 194 |
| Third process step | 196 |
| Flow conduit element | 198 |

What is claimed is:

1. A centrifugal separator comprising:
a stator assembly comprising at least one housing; and
a rotor assembly positioned within said at least one housing, said rotor assembly comprising:
a rotor shaft;
an array of longitudinal fins extending radially outward from said rotor shaft; and
a plurality of separator vanes coupled to said array of longitudinal fins, wherein each separator vane comprises a plurality of longitudinal slots defined therein and configured to align with said array of longitudinal fins such that said plurality of separator vanes are rotationally interlocked with said array of longitudinal fins.

2. The centrifugal separator in accordance with claim 1, wherein each separator vane comprises at least one angled flow surface oriented obliquely relative to a longitudinal axis of said rotor assembly such that an angled flow passage is defined between adjacent separator vanes.

3. The centrifugal separator in accordance with claim 2, wherein said plurality of separator vanes comprises:
a first separator vane comprising a first angled flow surface; and
a second separator vane comprising a second angled flow surface, said first angled flow surface and said second angled flow surface defining said angled flow passage having an intake opening and a discharge opening, wherein said first angled flow surface is oriented obliquely relative to said second angled flow surface such that said intake opening and said discharge opening have the same flow area.

4. The centrifugal separator in accordance with claim 1, wherein said plurality of separator vanes each comprise a radially outer surface and a radially inner surface such that a radially outer flow passage is defined between said at least one housing and said radially outer surface, and such that a radially inner flow passage is defined between said rotor shaft and said radially inner surface.

5. The centrifugal separator in accordance with claim 4, wherein said plurality of separator vanes are spaced between an inlet end and an outlet end of said at least one housing, said at least one housing comprising a side wall oriented such that a flow area of said radially outer flow passage decreases in size from said inlet end towards said outlet end.

6. The centrifugal separator in accordance with claim 4, wherein said plurality of separator vanes are positioned between an inlet end and an outlet end of said at least one housing, said rotor shaft comprising a surface oriented such that a flow area of said radially inner flow passage increases in size from said inlet end towards said outlet end.

7. The centrifugal separator in accordance with claim 4, wherein said at least one housing comprises:
a first housing comprising an inlet configured to receive a mixed stream of at least a first fluid and a second fluid and a first outlet in flow communication with said radially outer flow passage; and
a second housing comprising a second outlet in flow communication with said radially inner flow passage.

8. The centrifugal separator in accordance with claim 7, wherein said first housing and said second housing are sealed from each other.

9. The centrifugal separator in accordance with claim 1 further comprising a layer of hydrophobic coating material on at least one of said stator assembly or said rotor assembly.

10. A pump assembly for use in extracting fluid from a wellbore, said pump assembly comprising:
a submersible pump; and
a centrifugal separator in flow communication with said submersible pump, said centrifugal separator comprising:
a stator assembly comprising at least one housing configured to channel a mixed stream of at least a first fluid and a second fluid therethrough; and
a rotor assembly positioned within said at least one housing, said rotor assembly comprising:
a rotor shaft; and
a plurality of separator vanes coupled to said rotor shaft, wherein a plurality of angled flow passages are defined between adjacent separator vanes, a radially outer flow passage is defined between said plurality of separator vanes and said at least one housing, and a radially inner flow passage is defined between said plurality of separator vanes and said rotor shaft, said plurality of angled flow passages configured to provide flow communication between said radially outer flow passage and said radially inner flow passage such that, when said rotor assembly rotates, the mixed stream is separated based on a density of the first fluid and the second fluid.

11. The pump assembly in accordance with claim 10, wherein said at least one housing comprises an inlet and at least one outlet, said pump assembly further comprising an outflow valve in flow communication with said at least one outlet, said outflow valve configured to restrict flow discharged from said at least one outlet such that a back pressure is formed within said at least one housing.

12. The pump assembly in accordance with claim 10 further comprising a flow straightening device positioned between said submersible pump and said centrifugal separator.

13. The pump assembly in accordance with claim 10, wherein said submersible pump comprises a drive shaft coupled to said rotor shaft such that said centrifugal separator is actuated by rotation of said drive shaft.

14. The pump assembly in accordance with claim 10 further comprising a motor coupled to rotor shaft, said motor configured to actuate said centrifugal separator.

15. The pump assembly in accordance with claim 14, wherein said at least one housing comprises an inlet configured to receive a mixed stream of at least a first fluid and a second fluid, a first outlet in flow communication with said radially outer flow passage, and a second outlet in flow communication with said radially inner flow passage.

16. A method of assembling a centrifugal separator, said method comprising:
sliding a plurality of separator vanes onto a rotor assembly that includes a rotor shaft and an array of longitudinal fins extending radially outward from the rotor shaft, wherein the plurality of separator vanes include a plurality of longitudinal slots defined therein and configured to align with the array of longitudinal fins such that the plurality of separator vanes are rotationally interlocked with the array of longitudinal fins; and
positioning the rotor assembly within at least one housing of a stator assembly.

17. The method in accordance with claim 16, wherein positioning the rotor assembly within at least one housing comprises positioning the rotor assembly within a first housing and a second housing of the stator assembly, the first housing configured to discharge a first separated mixed stream and the second housing configured to discharge a second separated mixed stream therefrom.

18. The method in accordance with claim 17 further comprising sealing the first housing and the second housing from each other.

19. The method in accordance with claim 17, wherein a radially inner flow passage is defined between the plurality of separator vanes and the rotor shaft, said method further comprising sliding a flow conduit onto the rotor assembly, the flow conduit configured to provide fluid communication between the radially inner flow passage and the second housing.

20. The method in accordance with claim 16 further comprising coupling a motor to the rotor shaft, wherein the motor is configured to actuate the centrifugal separator.
